(19) United States
(12) Patent Application Publication
(10) Pub. No.: US 2017/0091420 A1
(43) Pub. Date: Mar. 30, 2017

(54) DETERMINATION OF NUTRITIONAL FACTORS

(71) Applicant: QUALCOMM Incorporated, San Diego, CA (US)

(72) Inventors: Matthew Christian DUGGAN, Tokyo (JP); Michael William PADDON, Tokyo (JP)

(21) Appl. No.: 14/863,677

(22) Filed: Sep. 24, 2015

(51) Int. Cl. G06F 19/00; H04W 4/02

(52) U.S. Cl. CPC G06F 19/3475; G06F 19/324; H04W 4/025

(57) ABSTRACT

A method, an apparatus, and a computer program product for wireless communication are provided. The apparatus can collect a plurality of environmental factors. The apparatus can refine a list of potential items being consumed by a user each time one of the plurality of environmental factors is collected until a confidence threshold is reached. The apparatus can select an item from the list of potential items being consumed by the user once the confidence threshold is reached. The apparatus can determine a set of nutritional factors associated with the item selected from the list of potential items being consumed by the user.

### BACKGROUND

Field

The present disclosure relates generally to communication systems, and more particularly, to a method, an apparatus, and a computer-readable medium to determine a set of nutritional factors associated with a consumable item with minimal or no interaction on the part of a user.

Background

Maintaining a healthy lifestyle generally involves considering both energy input (e.g., food consumption) and energy output (e.g., exercise). The health benefits of exercise are well documented, but for those interested in weight-loss and/or following a nutrition plan it may be beneficial for a user to monitor the types and/or quantities of food being consumed. Wearable fitness devices that can be used to monitor energy output are rapidly growing industry. These wearable fitness devices can include technology such as accelerometers, heart rate monitor bands and watches that may help a user monitor his/her fitness and movement throughout the day. In addition, wearable fitness devices may provide a surrounding cloud ecosystem to the user with respect to meeting his/her fitness goals: adding a nice user interface (UI), encouragement, sharing features, etc. While wearable fitness devices may not provide medically accurate information to the user, they may be able to provide a good enough measure of calorie expenditure from physical activity for the purposes of most users in monitoring fitness goals related to exercise.

However, with respect to monitoring food consumption these wearable fitness devices can be less easy to use. Various mobile apps (e.g., computer programs configured to run on a mobile device such as a smart phone or tablet computer) can be used to record food consumption from “standard” foods (e.g., such as pre-packaged items) by barcode scanning or selecting from common menus such as those of fast food restaurants. Unfortunately, food consumption using these mobile apps may be difficult to monitor when eating out or cooking at home. In addition, for users who eat out frequently, recording each food item consumed can also become an error-ridden chore, as it may require the user to estimate weight and makeup of the foods being consumed. Hence, there is a need for a simpler way to monitor food consumption with minimal effort on the part of the user that is able to add flexibility for “unknown” meals.

### SUMMARY

In an aspect of the disclosure, a method, an apparatus, and a computer program product for wireless communication are provided. The apparatus can collect a plurality of environmental factors. The apparatus can refine a list of potential items being consumed by a user each time one of the plurality of environmental factors is collected until a confidence threshold is reached. The apparatus can select an item from the list of potential items being consumed by the user once the confidence threshold is reached. The apparatus can determine a set of nutritional factors associated with the item selected from the list of potential items being consumed by the user.

### BRIEF DESCRIPTION OF THE DRAWINGS

FIG. 1 is a diagram illustrating an example of a network architecture.

FIG. 2 is a diagram illustrating an example of an evolved Node B and user equipment in an access network.

FIG. 3 is a diagram illustrating an exemplary embodiment.

FIGS. 4A-4D are a diagram illustrating exemplary embodiments.

FIG. 5 is a flowchart of a method of wireless communication.

FIG. 6 is a conceptual data flow diagram illustrating the data flow between different modules/means/components in an exemplary apparatus.

FIG. 7 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

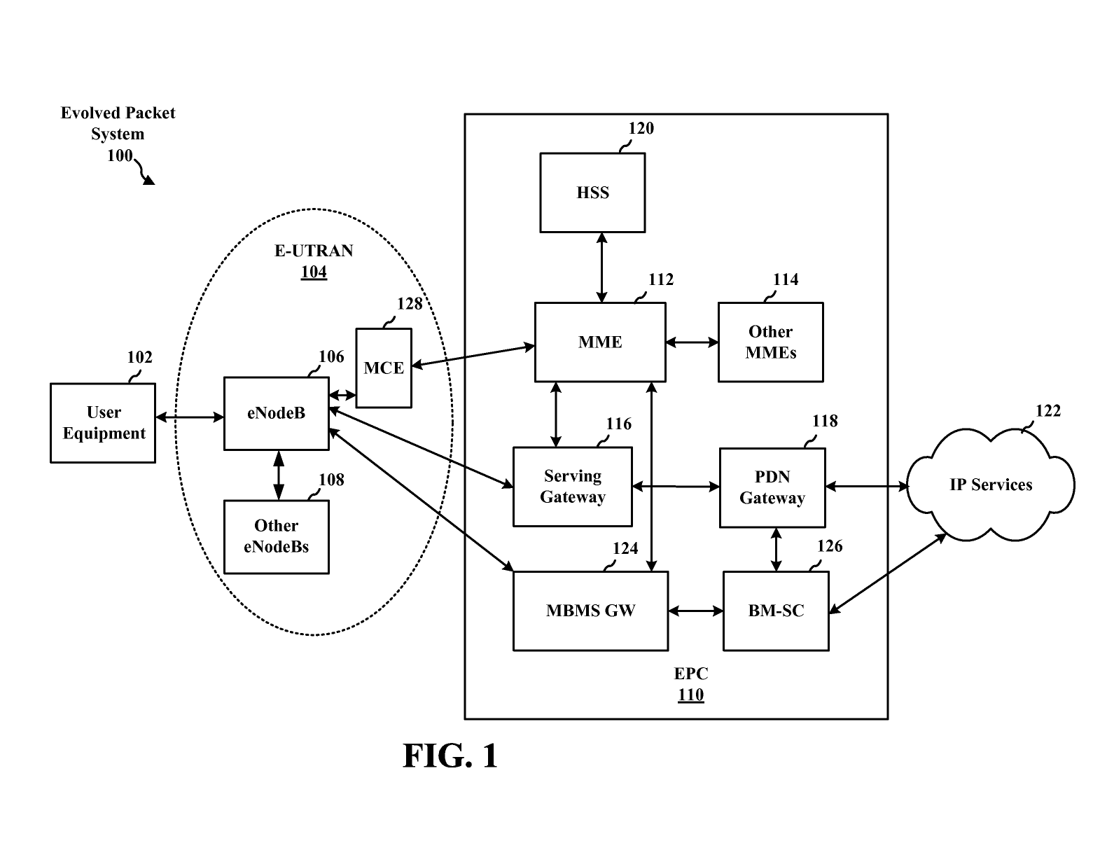

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

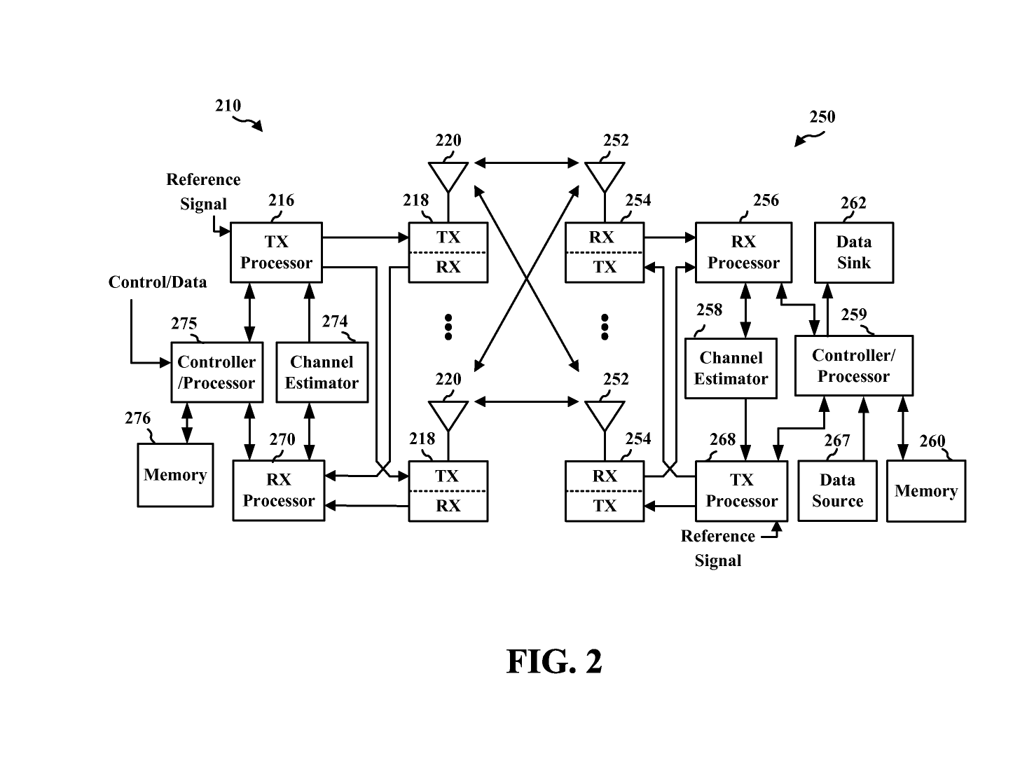

FIG. 2 is a block diagram of an eNB 210 in communication with a UE 250 in an access network. In the DL, upper layer packets from the core network are provided to a controller/processor 275. The controller/processor 275 implements the functionality of the L2 layer. In the DL, the controller/processor 275 provides header compression, ciphering, packet segmentation and reordering, multiplexing between logical and transport channels, and radio resource allocations to the UE 250 based on various priority metrics. The controller/processor 275 is also responsible for HARQ operations, retransmission of lost packets, and signaling to the UE 250.

The transmit (TX) processor 216 implements various signal processing functions for the L1 layer (i.e., physical layer). The signal processing functions include coding and interleaving to facilitate forward error correction (FEC) at the UE 250 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The RX processor 256 implements various signal processing functions of the L1 layer. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 210. These soft decisions may be based on channel estimates computed by the channel estimator 258. The soft decisions are then decoded and deinterleaved to recover the data and control signals that were originally transmitted by the eNB 210 on the physical channel. The data and control signals are then provided to the controller/processor 259.

The controller/processor 259 implements the L2 layer. The controller/processor can be associated with a memory 260 that stores program codes and data. The memory 260 may be referred to as a computer-readable medium. In the UL, the controller/processor 259 provides demultiplexing between transport and logical channels, packet reassembly, deciphering, header decompression, control signal processing to recover upper layer packets from the core network. The upper layer packets are then provided to a data sink 262, which represents all the protocol layers above the L2 layer. Various control signals may also be provided to the data sink 262 for L3 processing. The controller/processor 259 is also responsible for error detection using an acknowledgement (ACK) and/or negative acknowledgement (NACK) protocol to support HARQ operations.

In the UL, a data source 267 is used to provide upper layer packets to the controller/processor 259. The data source 267 represents all protocol layers above the L2 layer. Similar to the functionality described in connection with the DL transmission by the eNB 210, the controller/processor 259 implements the L2 layer for the user plane and the control plane by providing header compression, ciphering, packet segmentation and reordering, and multiplexing between logical and transport channels based on radio resource allocations by the eNB 210. The controller/processor 259 is also responsible for HARQ operations, retransmission of lost packets, and signaling to the eNB 210.

Channel estimates derived by a channel estimator 258 from a reference signal or feedback transmitted by the eNB 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission.

The UL transmission is processed at the eNB 210 in a manner similar to that described in connection with the receiver function at the UE 250. Each receiver 218RX receives a signal through its respective antenna 220. Each receiver 218RX recovers information modulated onto an RF carrier and provides the information to a RX processor 270. The RX processor 270 may implement the L1 layer.

The controller/processor 275 implements the L2 layer. The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover upper layer packets from the UE 250. Upper layer packets from the controller/processor 275 may be provided to the core network. The controller/processor 275 is also responsible for error detection using an ACK and/or NACK protocol to support HARQ operations.

Maintaining a healthy lifestyle generally involves considering both energy input (e.g., food consumption) and energy output (e.g., exercise). The health benefits of exercise are well documented, but for those interested in weight-loss and/or following a nutrition plan it may be beneficial for a user to monitor the types and/or quantities of food being consumed. Wearable fitness devices that can be used to monitor energy output are rapidly growing industry. These wearable fitness devices can include technology such as accelerometers, heart rate monitor bands and watches that may help a user monitor his/her fitness and movement throughout the day. In addition, wearable fitness devices may provide a surrounding cloud ecosystem to the user with respect to meeting his/her fitness goals: adding a nice user interface (UI), encouragement, sharing features, etc. While wearable fitness devices may not provide medically accurate information to the user, they may be able to provide a good enough measure of calorie expenditure from physical activity for the purposes of most users in monitoring fitness goals related to exercise.

However, with respect to monitoring food consumption these wearable fitness devices can be less easy to use. Various mobile apps (e.g., computer programs configured to run on a mobile device such as a smart phone or tablet computer) can be used to record food consumption from “standard” foods (e.g., such as pre-packaged items) by barcode scanning or selecting from common menus such as those of fast food restaurants. Unfortunately, food consumption using these mobile apps may be difficult to monitor when eating out or cooking at home. In addition, for users who eat out frequently, recording each food item consumed can also become an error-ridden chore, as it may require the user to estimate weight and makeup of the foods being consumed. Hence, there is a need for a simpler way to monitor food consumption with minimal effort on the part of the user that is able to add flexibility for “unknown” meals.

Thus, the present disclosure provides a method, apparatus, and computer-readable medium that is able to record and provide information related to a user's food consumption with little or no interaction required on the part of the user. When interaction on the part of the user is required, the present apparatus can include integrated gauges and/or sensors that are able to measure the weight and/or chemical makeup of consumable items to determine a set of nutritional factors associated with a food item that is going to be consumed by the user. In this way, the present disclosure is able to provide a simpler and more seamless way for a user to monitor food consumption that is able to add flexibility for “unknown” meals.

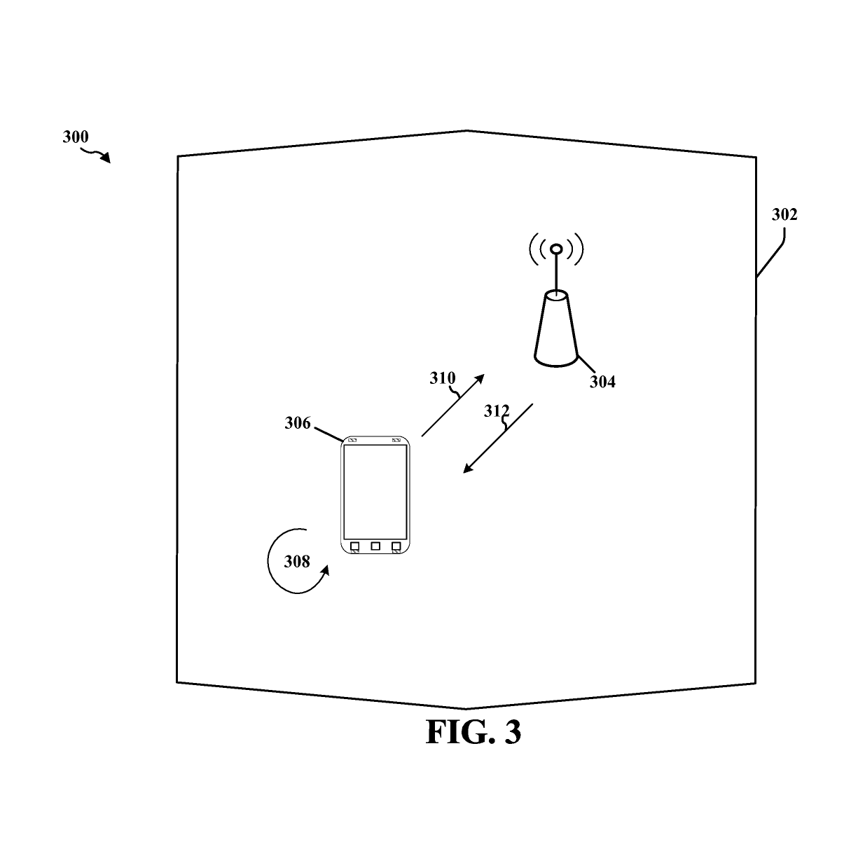

FIG. 3 is a diagram of a wireless communications system 300. Serving cell 302 is the region served by eNB 304. A UE 306 located in serving cell 302 can perform various processes for determining a set of nutritional factors associated with potential item(s) that may be consumed by a user. For example, the UE 306 can collect 308 a plurality of environmental factors that can be used to infer one or more potential items being consumed by the user. The UE 306 may begin collecting environmental factors based on user initiation, or automatically based on a time of day. In an aspect, each time one of the environmental factors is collected by the UE 306, a list of potential items being consumed by the user can be refined 308 until a confidence threshold is reached. Once the confidence threshold is reached, the UE 306 can select 308 an item from the list of potential items being consumed by the user and determine 308 a set of nutritional factors associated with the selected item. However, if the confidence threshold is not reached within a predetermined amount of time, the UE 306 may prompt 308 the user for input regarding the potential items being consumed. For example, the UE 306 may display a list of foods the user is potentially consuming, and request that the user select one or more items from the list.

Referring to FIG. 3, in an aspect, one of the environmental factors collected by the UE 306 may include location information associated with the UE 306. The location of the UE 306 can be inferred, for example, from location information 312 obtained from the eNB 304 or from another positioning system (e.g., such as satellites used in a global positioning system or a Wi-Fi access point located in a restaurant). The location can include, for example, a restaurant, a café, a food truck, a bar, a diner, a coffee shop, and/or a juice bar, just to name a few. In an aspect, the location information associated with the UE 306, combined with map data obtained by the UE 306 can be used to determine a list of candidate restaurants at which the user may be dining Based on the location information 312, the UE 306 can refine the list of potential items being consumed by obtaining 308 a list of consumable items associated with the location of the UE and selecting 308 at least one consumable item associated with the location of the UE. For example, the list of potential items being consumed by the user may be refined based on menu items associated with a candidate restaurants identified by the UE 306. In an aspect, the list of consumable items may include at least one of items previously consumed by the user at the location associated with the UE 306 or items consumed by other users at the location associated with the UE 306. In this way, the list of potential items being consumed by the user can be refined 308 by the UE 306 with little or no input from the user, thereby providing a more pleasing user experience.

Still referring to FIG. 3, in another aspect, one of the environmental factors collected by the UE 306 may include an ambient temperature associated with the location of the UE 306. In an aspect, the at least one consumable item may be selected from the list of consumable items by the UE 306 based on the ambient temperature associated with the location of the UE. For example, if the ambient temperature is hot and the user generally eats cooler foods on hotter days, it may be more likely that the user is having ice cream than hot soup. Thus, due to the higher probability of cold food consumption than hot food consumption due to the ambient temperature, the UE 306 may select the cold food items from the list of consumable items. In an aspect, the list of consumable items associated ambient temperature of the UE may include at least one of items previously consumed by the user on days with the same or similar ambient temperature or items consumed by other users at on days with the same or similar ambient temperature. In this way, the list of potential items being consumed by the user can be further refined 308 by the UE 306 based on the ambient temperature without the need for input from the user.

Referring again to FIG. 3, in still another aspect, one of the environmental factors collected by the UE 306 may include a time of day associated with the location of the UE 306. In an aspect, the at least one consumable item may be selected 308 from the list of consumable items by the UE 306 based on the time of day. For example, if it is determined that the time of day is in the morning, it may be highly likely the user is eating breakfast food(s) such as eggs, bacon, cereal, juice, coffee, and/or tea. Thus, due to the higher probability that the user is eating foods associated with breakfast than lunch or dinner, the UE 306 may select the breakfast food(s) from the list of consumable items. In this way, the list of potential items being consumed by the user can be further refined 308 by the UE 306 based on the time of day.

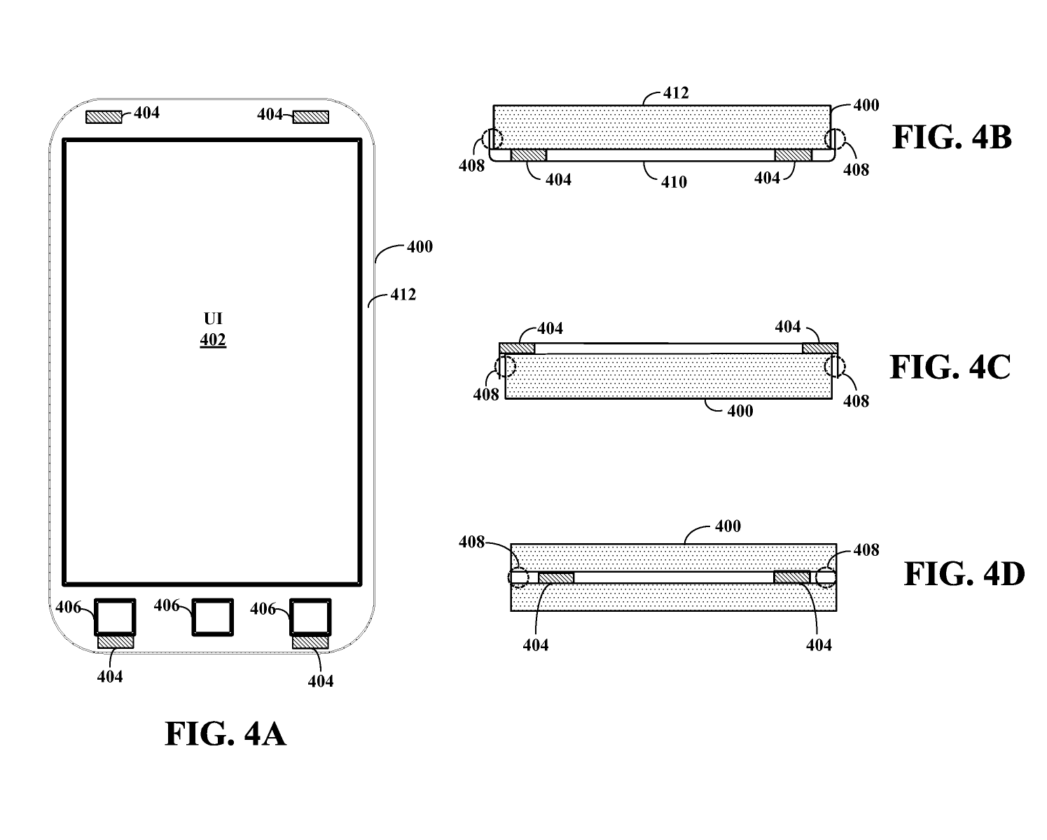

Referring again to FIG. 3, in a further aspect, one environmental factor collected by the UE 306 may include a weight of the food item, which can be measured using strain gauges in the UE 306 (e.g., which are further described with respect to FIGS. 4A-4D). Another environmental factor collected by the UE 306 may include a chemical composition of the food item, which can be measured using a semiconductor sensor device in the UE 306 (e.g., described in more detail with respect to FIGS. 4A-4D). Still further, another environmental factor collected by the UE 306 may include a spectral composition of the food item using a molecular sensor in the UE 306 (e.g., described in more detail with respect to FIGS. 4A-4D). In addition, one environmental factor that may be collected by the UE 306 is one or more photographs of the food item. Another environmental factor that may be collected by the UE 306 includes a 3D model of the food item that can be obtained using multiple cameras on the UE 306 and/or a “structure from motion” system included in the UE 306 or located externally from the UE 306. A “structure from motion” system can produce a 3D model that may be constructed from a video sequence taken by a moving device, such as the UE 306. Hints and/or detailed information input directly by the user, such as a highly-simplified 3-4 category scale of calorie density or choosing exact foods or products from a list may also be an environmental factor collected by the UE 306. One of the environmental factors collected by the UE 306 may also include a barcode scanned from a product package for pre-packaged meals. However, collecting one or more photographs, a 3D model, hints and/or detailed information, and/or barcode information related to the food item may require input on the part of the user, and thus may be used as a last resort to reach the confidence threshold by the UE 306 in order to limit the interaction required by the user.

Once the confidence threshold is reached based on refinement of the list of potential items being consumed by the user, the UE 306 can select 308 an item from the list and determine 308 a set of nutritional factors associated with the selected item. In an aspect, the UE 306 can refine 308 the set of nutritional factors associated with the selected item until a target accuracy level associated with the set of nutritional factors is reached. In an aspect, the target accuracy level may be set based on input from the user or may be automatically selected by the UE 306. For example, if a user is interested in only a general idea of the nutritional factors related to the food being consumed, the target accuracy level may be lower than that of a user who is interested in a more specific understanding of the nutritional factors associated with food being consumed.

The higher the target accuracy level, the more refinement of the nutritional factors that may need to be performed by the UE 306. In an aspect, the UE 306 can refine 308 the set of nutritional factors by determining a potential volume of the selected item, determining a potential weight of the selected item using information obtained by one or more strain gauges in the UE (e.g., described in more detail with respect to FIGS. 4A-4D), determining a potential chemical makeup of the selected item using information obtained by one or more semiconductor and/or molecular sensors in the UE (e.g., described in more detail with respect to FIGS. 4A-4D), determining a potential calorie amount of the selected item, determining a potential protein amount of the selected item, or determining a potential carbohydrate amount of the selected item. For example, the UE 306 can use the chemical makeup and/or weight determinations in conjunction with a list of known foods and their weight-density and calorific-densities. By combining this information the UE 306 may be able to calculate a total calorie count for food being consumed by the user.

Once the target accuracy level is reached based on the refinement of the nutritional factors, the UE 306 may be able to perform various operations with this information. For example, the UE 306 may display the nutritional factors on a UI. Additionally and/or alternatively, the information associated with the nutritional factors can be stored in a memory of the UE 308 and/or an external database via transmission 310 to the eNB 304. For example, the transmission 310 can be sent to an online service for a human to analyze. By way of example, a human classifier who receives a photograph of a steak and fries with a red-colored beer on the side may be able to estimate the size of the steak and how many fries are being or were consumed by the user. The output produced by the online may be something like “300 g beef, 200 g fries, 1 pint red beer”, which can be transmitted 312 by the eNB 304 the UE 306 for display and/or storage on the UE 306.

Alternatively, for a more automated classification system, the UE 306 or an external service may employ a machine-learning based approach. For example, “Support Vector Machines” or “Deep Neural Network” classifiers can be used by the UE 306 to classify photographs, videos, spectral measurements, or chemical measurements into known foods (“classes”) based on a model of each class. The models can incorporate information related to the user's food history and the types of foods available in restaurants around them to weight probability estimates. A composition estimate can be turned into a volume or weight estimate using either the weight, 3D model information, or information input directly by the user.

In this way, the present disclosure is able to provide a simpler and more seamless way for a user to monitor food consumption that is able to add flexibility for “unknown” meals.

FIGS. 4A-4D are diagrams of a wireless communications apparatus 400400, such as UE 306 described above with respect to FIG. 3. As illustrated in FIGS. 4B-4D, the wireless communications apparatus 400 may include a back panel 410 (e.g., illustrated in FIGS. 4B-4D) can be coupled to the front panel 412, for example, at region 408 using one or more clips, fasteners, screens, and/or adhesives, just to name a few. As illustrated in FIG. 4A, the front panel 412 may includes a UI 402 which may be used to display prompts for user input related to potential food items being consumed by the user.

Still referring to FIG. 4A, the UI 402 may also be used to display information related to the nutritional factors associated with the food items being consumed by the user. For example, the information can be displayed in the form of text, an audio message, a line graph, a percentage, a pie chart, and/or a histogram, just to name a few. For example, if the UE 400 prompts the user for input related to potential food items being consumed, the user can respond by inputting information using one or more buttons 406 located on the UE 400. Alternatively and/or additionally, the user may input information into the UE 400 using a touch screen capability of the UI 402.

Referring again to FIG. 4A, the UE 400 may include a plurality of sensors 404 that may be configured to measure various properties, such as weight and/or chemical makeup, associated with food being consumed by a user.

In a first aspect, one or more of the sensors 404 may include a strain gauge that is configured to measure strain between the front and back surfaces, thereby enabling the UE 400 to act as an electronic scale. For example, the user may place a food item on the UE 400, and the sensors 404 that include the strain gauge can measure the weight of the food item. For example, a prompt on the UI 402 may request that the user place the item of food onto the surface of the UE 400 for weight measurement. The weight measurement may, for example, be used by the UE 400 to refine a set of nutritional factors associated with the food item. The strain gauge 404 may include various different configurations depending on the physical design of the UE 400 without departing from the scope of the present disclosure.

For example, as illustrated in FIG. 4B, the strain gauges 404 may be built into the back panel 410 of the UE 400, or the strain gauges may be built on the corners of the back panel 410 as illustrated in FIG. 4C. In an alternative aspect, the strain gauges 404 may be built into the sides of the UE 400, in the connection between the back panel 410 and front panel 412. Then when the user wishes to measure the weight of a food item(s) (e.g., which may be based on prompts displayed on UI 402), the user may place a food item and/or a plate of food on the front surface 412 or the back surface 410 of the UE 400. The strain gauges measure the weight of the food item(s) and/or the plate of food. Once the meal and/or snack is finished, the user can then record the weight of the unconsumed portion of the food item(s) and or plate by again using the UE 400 as a scale.

In a second exemplary embodiment, one or more of the sensors 404 may include a semiconductor “electronic nose” device that is able to “sniff” an item of food and/or a meal placed near the sensors 404 to determine the composition of a food item and/or meal. In a third exemplary embodiment, one or more of the sensors 404 may include a molecular sensor that allows a high-resolution electromagnetic spectrum measurement in a compact form factor of a food item to be taken and used to determine the composition of the food item. The UE 400 can then determine one or more nutritional factors associated with the food item based on the weight of the food item and/or the composition of the food item.

In this way, the present disclosure is able to provide a simpler and more seamless way for a user to monitor food consumption that is able to add flexibility for “unknown” meals.

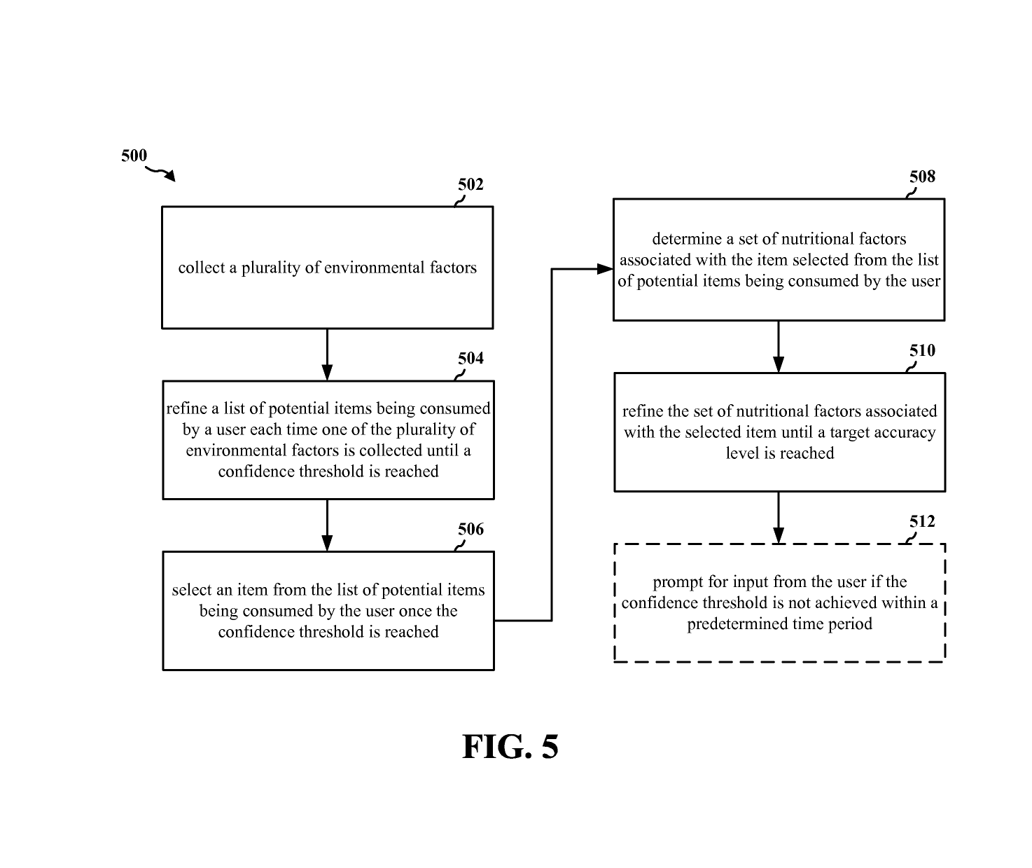

FIG. 5 is a flowchart 500 of a method of wireless communication. The method may be performed by a UE (e.g., the UE 306/400, the apparatus 602/602′). It should be understood that the operations indicated with dashed lines represent operations for various aspects of the disclosure.

In step 502, the UE can collect a plurality of environmental factors. In an aspect, the collecting the plurality of environmental factors comprises determining a location of the UE. In another aspect, the collecting the plurality of environmental factors further comprises determining an ambient temperature associated with the location of the UE. In a further aspect, the collecting the plurality of environmental factors further comprises determining a time of day associated with the location of the UE. For example, referring to FIG. 3, in a further aspect, one environmental factor collected by the UE 306 may include a weight of the food item, which can be measured using strain gauges in the UE 306 (e.g., which are further described with respect to FIGS. 4A-4D). Another environmental factor collected by the UE 306 may include a chemical composition of the food item, which can be measured using a semiconductor sensor device in the UE 306 (e.g., described in more detail with respect to FIGS. 4A-4D). Still further, another environmental factor collected by the UE 306 may include a spectral composition of the food item using a molecular sensor in the UE 306 (e.g., described in more detail with respect to FIGS. 4A-4D). In addition, one environmental factor that may be collected by the UE 306 is one or more photographs of the food item. Another environmental factor that may be collected by the UE 306 includes a 3D model of the food item that can be obtained using multiple cameras on the UE 306 and/or a “structure from motion” system included in the UE 306 or located externally from the UE 306. A “structure from motion” system can produce a 3D model that may be constructed from a video sequence taken by a moving device, such as the UE 306. Hints and/or detailed information input directly by the user, such as a highly-simplified 3-4 category scale of calorie density or choosing exact foods or products from a list may also be an environmental factor collected by the UE 306. One of the environmental factors collected by the UE 306 may also include a barcode scanned from a product package for pre-packaged meals. However, collecting one or more photographs, a 3D model, hints and/or detailed information, and/or barcode information related to the food item may require input on the part of the user, and thus may be used as a last resort to reach the confidence threshold by the UE 306 in order to limit the interaction required by the user.

In step 504, the UE can refine a list of potential items being consumed by a user each time one of the plurality of environmental factors is collected until a confidence threshold is reached. In an aspect, the refining the list of potential items being consumed by a user comprises obtaining a list of consumable items associated with the location of the UE and selecting at least one consumable item from the list of consumable items associated with the location of the UE. In a further aspect, the list of consumable items associated with the location of the UE includes at least one of items previously consumed by the user at the location of the UE or items consumed by other users at the location associated with the UE.

In step 506, the UE can select an item from the list of potential items being consumed by the user once the confidence threshold is reached. In an aspect, the at least one consumable item is selected from the list of consumable items based on the ambient temperature associated with the location of the UE. In another aspect, the at least one consumable item is selected from the list of consumable items based on the time of day associated with the location of the UE.

In step 508, the UE can determine a set of nutritional factors associated with the item selected from the list of potential items being consumed by the user.

In step 510, the UE can refine the set of nutritional factors associated with the selected item until a target accuracy level is reached. In an aspect, the refining the set of nutritional factors associated with the selected item comprises one or more of determining a potential volume of the selected item, determining a potential weight of the selected item using information obtained by one or more gauges imbedded in the UE, determining a potential chemical makeup of the selected item using information obtained by one or more sensors imbedded in the UE, determining a potential calorie amount of the selected item, determining a potential protein amount of the selected item, or determining a potential carbohydrate amount of the selected item. For example, referring to FIG. 3, the UE 306 can refine 308 the set of nutritional factors associated with the selected item until a target accuracy level associated with the set of nutritional factors is reached. In an aspect, the target accuracy level may be set based on input from the user or may be automatically selected by the UE 306. For example, if a user is interested in only a general idea of the nutritional factors related to the food being consumed, the target accuracy level may be lower than that of a user who is interested in a more specific understanding of the nutritional factors associated with food being consumed. The higher the target accuracy level, the more refinement of the nutritional factors that may need to be performed by the UE 306. In an aspect, the UE 306 can refine 308 the set of nutritional factors by determining a potential volume of the selected item, determining a potential weight of the selected item using information obtained by one or more strain gauges in the UE (e.g., described in more detail with respect to FIGS. 4A-4D), determining a potential chemical makeup of the selected item using information obtained by one or more semiconductor and/or molecular sensors in the UE (e.g., described in more detail with respect to FIGS. 4A-4D), determining a potential calorie amount of the selected item, determining a potential protein amount of the selected item, or determining a potential carbohydrate amount of the selected item. For example, the UE 306 can use the chemical makeup and/or weight determinations in conjunction with a list of known foods and their weight-density and calorific-densities. By combining this information the UE 306 may be able to calculate a total calorie count for food being consumed by the user

In step 512, the UE can prompt for input from the user if the confidence threshold is not achieved within a predetermined time period. For example, referring to FIG. 4A, the UE 400 may include a UI 402 which may be used to display prompts for user input related to potential food items being consumed by the user.

In this way, the present disclosure is able to provide a simpler and more seamless way for a user to monitor food consumption that is able to add flexibility for “unknown” meals.

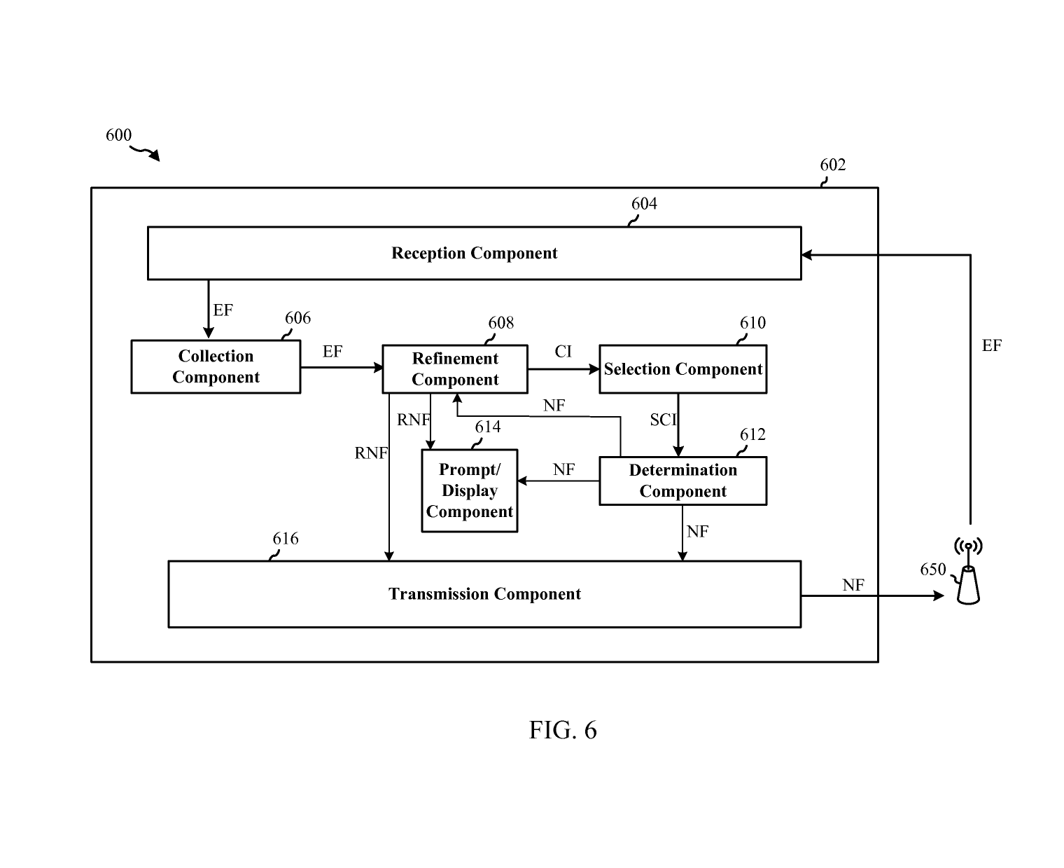

FIG. 6 is a conceptual data flow diagram 600 illustrating the data flow between different modules/means/components in an exemplary apparatus 602. The apparatus may be a UE. The apparatus includes a reception component 604, a collection component 606, a refinement component 608, a selection component 610, a determination component 612, a prompt/display component 614, and a transmission component 616.

At reception component 604, the UE 602 can receive information from eNB 650. For example, the information can be related to environmental factors (EF) such as location, ambient temperature, time of day, menu items, etc. Reception component 604 can send a signal related to the EF to the collection component 606.

At collection component 606, the UE 602 can collect a plurality of environmental factors. In an aspect, the collection component 606 can collect the plurality of environmental factors by determining a location of the UE 602. For example, the location of the UE 602 can be determined based on the information sent by the eNB 650. In another aspect, the collection component 606 can collect the plurality of environmental factors by determining an ambient temperature associated with the location of the UE 602. For example, the ambient temperature can be determined based on the information sent from eNB 650. In a further aspect, the collection component 606 can collect the plurality of environmental factors by determining a time of day associated with the location of the UE 602. For example, one environmental factor collected by the collection component 606 may include a weight of the food item. Another environmental factor collected by the collection component 606 may include a chemical composition of the food item. Still further, another environmental factor collected by the collection component 606 may include a spectral composition of the food item. In addition, one environmental factor that may be collected by the collection component 606 is one or more photographs of the food item. Another environmental factor that may be collected by the collection component 606 includes a 3D model of the food item. One of the environmental factors collected by the collection component 606 may also include a barcode scanned from a product package for pre-packaged meals. In an aspect, the collection component 606 can send a signal related to an environmental factors (EF) to the refinement component 608 each time information related to one of the environmental factors is collected.

At refinement component 608, the UE 602 can refine a list of potential items being consumed by a user each time one of the plurality of environmental factors is collected until a confidence threshold is reached. In an aspect, the refinement component 608 can refine the list of potential items being consumed by a user by obtaining a list of consumable items associated with the location of the UE 602 and selecting at least one consumable item from the list of consumable items associated with the location of the UE 602. In a further aspect, the list of consumable items associated with the location of the UE 602 includes at least one of items previously consumed by the user at the location of the UE 602 or items consumed by other users at the location associated with the UE 602. The refinement component 608 can send a signal related to one or more consumable items (CI) to selection component 610 once the confidence threshold is reached.

At the selection component 610, the UE 602 can select an item from the list of potential items being consumed by the user once the confidence threshold is reached. In an aspect, the selection component 610 selects the at least one consumable item from the list of consumable items based on the ambient temperature associated with the location of the UE 602. In another aspect, selection component 610 selects the at least one consumable item from the list of consumable items based on the time of day associated with the location of the UE 602. The selection component 610 can send a signal related to the selected consumable item(s) (SCI) to the determination component 612.

At the determination component 612, the UE 602 can determine a set of nutritional factors associated with the item selected from the list of potential items being consumed by the user. If the set of nutritional factors do not require refinement, the determination component 612 can send a signal related to the set of nutritional factors (NF) to the prompt/display component 614 and/or transmission component 616. However, if the set of nutritional factors does require refinement, the determination component 612 can send a signal related to the set of nutritional factors (NF) to the refinement component 608.

At refinement component 608, the UE 602 can refine the set of nutritional factors associated with the selected item until a target accuracy level is reached. In an aspect, the refinement component 608 can refine the set of nutritional factors associated with the selected item by one or more of determining a potential volume of the selected item, determining a potential weight of the selected item using information obtained by one or more gauges imbedded in the UE 602, determining a potential chemical makeup of the selected item using information obtained by one or more sensors imbedded in the UE 602, determining a potential calorie amount of the selected item, determining a potential protein amount of the selected item, or determining a potential carbohydrate amount of the selected item. For example, the refinement component 608 can refine the set of nutritional factors associated with the selected item until a target accuracy level associated with the set of nutritional factors is reached. In an aspect, the target accuracy level may be set based on input from the user or may be automatically selected by the UE 602. The refinement component 608 can send a signal related to the refined nutritional factor(s) (RNF) to the prompt/display component 614 and/or the transmission component 616.

At the prompt/display component 614, the UE 602 can prompt for input from the user if the confidence threshold is not achieved within a predetermined time period. For example, the prompt/display component 614 may include a UI which may be used to display prompts for user input related to potential food items being consumed by the user.

The apparatus may include additional components that perform each of the blocks of the algorithm in the aforementioned flowcharts of FIG. 5. As such, each block in the aforementioned flowcharts of FIG. 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

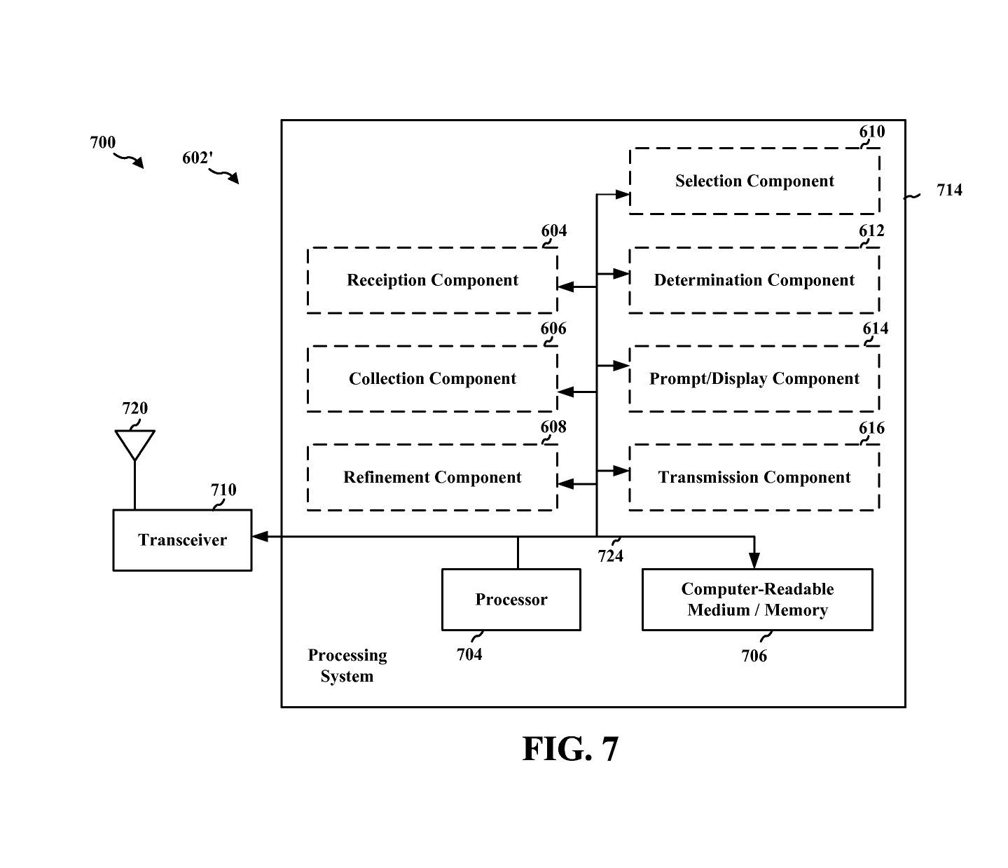

FIG. 7 is a diagram 700 illustrating an example of a hardware implementation for an apparatus 602′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware components, represented by the processor 704, the components 604, 606, 608, 610, 612, 614, and 616 and the computer-readable medium/memory 706. The bus 724 may also link various other circuits such as timing sources, peripherals, voltage regulators, and power management circuits, which are well known in the art, and therefore, will not be described any further.

The processing system 714 may be coupled to a transceiver 710. The transceiver 710 is coupled to one or more antennas 720. The transceiver 710 provides a means for communicating with various other apparatus over a transmission medium. The transceiver 710 receives a signal from the one or more antennas 720, extracts information from the received signal, and provides the extracted information to the processing system 714, specifically the reception component 604. In addition, the transceiver 710 receives information from the processing system 714, specifically the transmission component 616, and based on the received information, generates a signal to be applied to the one or more antennas 720. The processing system 714 includes a processor 704 coupled to a computer-readable medium/memory 706. The processor 704 is responsible for general processing, including the execution of software stored on the computer-readable medium/memory 706. The software, when executed by the processor 704, causes the processing system 714 to perform the various functions described supra for any particular apparatus. The computer-readable medium/memory 706 may also be used for storing data that is manipulated by the processor 704 when executing software. The processing system further includes at least one of the components 604, 606, 608, 610, 612, 614, and 616. The components may be software components running in the processor 704, resident/stored in the computer readable medium/memory 706, one or more hardware components coupled to the processor 704, or some combination thereof. The processing system 714 may be a component of the UE 250 and may include the memory 260 and/or at least one of the TX processor 268, the RX processor 256, and the controller/processor 259.

In one configuration, the apparatus 602/602′ for wireless communication includes means for collecting a plurality of environmental factors. In a further aspect, the apparatus 602/602′ for wireless communication includes means for refining a list of potential items being consumed by a user each time one of the plurality of environmental factors is collected until a confidence threshold is reached. In still a further aspect, the apparatus 602/602′ for wireless communication includes means for selecting an item from the list of potential items being consumed by the user once the confidence threshold is reached. In another aspect, the apparatus 602/602′ for wireless communication includes means for determining a set of nutritional factors associated with the item selected from the list of potential items being consumed by the user. Further, wherein the means for collecting the plurality of environmental factors is configured to determine a location of the UE, and the means for refining the list of potential items being consumed by a user is configured to obtain a list of consumable items associated with the location of the UE and selecting at least one consumable item from the list of consumable items associated with the location of the UE. Moreover, the list of consumable items associated with the location of the UE includes at least one of items previously consumed by the user at the location of the UE or items consumed by other users at the location associated with the UE. In addition, the means for collecting the plurality of environmental factors is further configured to determine an ambient temperature associated with the location of the UE. Furthermore, the at least one consumable item is selected from the list of consumable items based on the ambient temperature associated with the location of the UE. Additionally, the means for collecting the plurality of environmental factors is further configured to determine a time of day associated with the location of the UE. Still further, the at least one consumable item is selected from the list of consumable items based on the time of day associated with the location of the UE. In yet another aspect, the apparatus 602/602′ for wireless communication includes means for refining the set of nutritional factors associated with the selected item until a target accuracy level is reached. Moreover, the means for refining the set of nutritional factors associated with the selected item is configured to determine a potential volume of the selected item, determine a potential weight of the selected item using information obtained by one or more gauges imbedded in the UE, determine a potential chemical makeup of the selected item using information obtained by one or more sensors imbedded in the UE, determine a potential calorie amount of the selected item, determine a potential protein amount of the selected item, or determine a potential carbohydrate amount of the selected item. In another aspect, the apparatus 602/602′ for wireless communication includes means for prompting for input from the user if the confidence threshold is not achieved within a predetermined time period. The aforementioned means may be one or more of the aforementioned components of the apparatus 602 and/or the processing system 714 of the apparatus 602′ configured to perform the functions recited by the aforementioned means. As described supra, the processing system 714 may include the TX Processor 268, the RX Processor 256, and the controller/processor 259. As such, in one configuration, the aforementioned means may be the TX Processor 268, the RX Processor 256, and the controller/processor 259 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method comprising:
collecting, using a user equipment (UE), a plurality of environmental factors;
refining a list of potential items being consumed by a user each time one of the plurality of environmental factors is collected until a confidence threshold is reached;
selecting an item from the list of potential items being consumed by the user once the confidence threshold is reached; and
determining a set of nutritional factors associated with the item selected from the list of potential items being consumed by the user.

2. The method of claim 1, wherein:
the collecting the plurality of environmental factors comprises determining a location of the UE; and
the refining the list of potential items being consumed by a user comprises obtaining a list of consumable items associated with the location of the UE and selecting at least one consumable item from the list of consumable items associated with the location of the UE.

3. The method of claim 2, wherein the list of consumable items associated with the location of the UE includes at least one of items previously consumed by the user at the location of the UE or items consumed by other users at the location associated with the UE.

4. The method of claim 2, wherein the collecting the plurality of environmental factors further comprises:
determining an ambient temperature associated with the location of the UE.

5. The method of claim 4, wherein the at least one consumable item is selected from the list of consumable items based on the ambient temperature associated with the location of the UE.

6. The method of claim 5, wherein the collecting the plurality of environmental factors further comprises:
determining a time of day associated with the location of the UE.

7. The method of claim 6, wherein the at least one consumable item is selected from the list of consumable items based on the time of day associated with the location of the UE.

8. The method of claim 1, further comprising:
refining the set of nutritional factors associated with the selected item until a target accuracy level is reached.

9. The method of claim 8, wherein the refining the set of nutritional factors associated with the selected item comprises one or more of:
determining a potential volume of the selected item;
determining a potential weight of the selected item using information obtained by one or more gauges imbedded in the UE;
determining a potential chemical makeup of the selected item using information obtained by one or more sensors imbedded in the UE;
determining a potential calorie amount of the selected item;
determining a potential protein amount of the selected item; or
determining a potential carbohydrate amount of the selected item.

10. The method of claim 1, further comprising:
prompting for input from the user if the confidence threshold is not achieved within a predetermined time period.

11. An apparatus comprising:
means for collecting, using a user equipment (UE), a plurality of environmental factors;
means for refining a list of potential items being consumed by a user each time one of the plurality of environmental factors is collected until a confidence threshold is reached;
means for selecting an item from the list of potential items being consumed by the user once the confidence threshold is reached; and
means for determining a set of nutritional factors associated with the item selected from the list of potential items being consumed by the user.

12. The apparatus of claim 11, wherein:
the means for collecting the plurality of environmental factors is configured to determine a location of the UE; and
the means for refining the list of potential items being consumed by a user is configured to obtain a list of consumable items associated with the location of the UE and select at least one consumable item from the list of consumable items associated with the location of the UE.

13. The apparatus of claim 12, wherein the list of consumable items associated with the location of the UE includes at least one of items previously consumed by the user at the location of the UE or items consumed by other users at the location associated with the UE.

14. The apparatus of claim 12, wherein the means for collecting the plurality of environmental factors is further configured to:
determine an ambient temperature associated with the location of the UE.

15. The apparatus of claim 14, wherein the at least one consumable item is selected from the list of consumable items based on the ambient temperature associated with the location of the UE.

16. The apparatus of claim 15, wherein the means for collecting the plurality of environmental factors is further configured to:
determine a time of day associated with the location of the UE.

17. The apparatus of claim 16, wherein the at least one consumable item is selected from the list of consumable items based on the time of day associated with the location of the UE.

18. The apparatus of claim 11, further comprising:
means for refining the set of nutritional factors associated with the selected item until a target accuracy level is reached.

19. The apparatus of claim 18, wherein the means for refining the set of nutritional factors associated with the selected item is configured to:
determine a potential volume of the selected item;
determine a potential weight of the selected item using information obtained by one or more gauges imbedded in the UE;
determine a potential chemical makeup of the selected item using information obtained by one or more sensors imbedded in the UE;
determine a potential calorie amount of the selected item;
determine a potential protein amount of the selected item; or
determine a potential carbohydrate amount of the selected item.

20. The apparatus of claim 11, further comprising:
means for prompting for input from the user if the confidence threshold is not achieved within a predetermined time period.

21. An apparatus comprising:
a memory; and
at least one processor coupled to the memory and configured to:
collect, using a user equipment (UE), a plurality of environmental factors;
refine a list of potential items being consumed by a user each time one of the plurality of environmental factors is collected until a confidence threshold is reached;
select an item from the list of potential items being consumed by the user once the confidence threshold is reached; and
determine a set of nutritional factors associated with the item selected from the list of potential items being consumed by the user.

22. The apparatus of claim 21, wherein:
the at least one processor is configured to collect the plurality of environmental factors by determining a location of the UE; and
the at least one processor is configured to refine the list of potential items being consumed by a user by obtaining a list of consumable items associated with the location of the UE and selecting at least one consumable item from the list of consumable items associated with the location of the UE.

23. The apparatus of claim 22, wherein the list of consumable items associated with the location of the UE includes at least one of items previously consumed by the user at the location of the UE or items consumed by other users at the location associated with the UE.

24. The apparatus of claim 22, wherein the at least one processor is configured to collect the plurality of environmental factors by further:
determining an ambient temperature associated with the location of the UE.

25. The apparatus of claim 24, wherein the at least one consumable item is selected from the list of consumable items based on the ambient temperature associated with the location of the UE.

26. The apparatus of claim 25, wherein the at least one processor is configured to collect the plurality of environmental factors by further:
determining a time of day associated with the location of the UE.

27. The apparatus of claim 26, wherein the at least one consumable item is selected from the list of consumable items based on the time of day associated with the location of the UE.

28. The apparatus of claim 21, wherein the apt least one processor is further configured to:
refine the set of nutritional factors associated with the selected item until a target accuracy level is reached.

29. The apparatus of claim 28, wherein the at least one processor is configured to refine the set of nutritional factors associated with the selected item by one or more of:
determining a potential volume of the selected item;
determining a potential weight of the selected item using information obtained by one or more gauges imbedded in the UE;
determining a potential chemical makeup of the selected item using information obtained by one or more sensors imbedded in the UE;
determining a potential calorie amount of the selected item;
determining a potential protein amount of the selected item; or
determining a potential carbohydrate amount of the selected item.

30. A computer-readable medium storing computer executable code for wireless communication, comprising code for:
collecting, using a user equipment (UE), a plurality of environmental factors;
refining a list of potential items being consumed by a user each time one of the plurality of environmental factors is collected until a confidence threshold is reached;
selecting an item from the list of potential items being consumed by the user once the confidence threshold is reached; and
determining a set of nutritional factors associated with the item selected from the list of potential items being consumed by the user.
